(19) United States
(12) Patent Application Publication
(10) Pub. No.: US 2014/0284318 A1
(43) Pub. Date: Sep. 25, 2014

(54) Water Heater Jacket

(71) Applicant: Dow Global Technologies LLC, Midland, MI (US)

(72) Inventors: Ashishkumar S. Lokhande, Pune (IN); Onkareshwar V. Bijiargi, Pune (IN); Nilesh Tawde, Mumbai (IN)

(73) Assignee: Dow Global Technologies LLC, Midland, MI (US)

(21) Appl. No.: 14/359,966

(22) PCT Filed: Dec. 3, 2012
(86) PCT No.: PCT/US2012/067534

§ 371 Date: May 22, 2014

(30) Foreign Application Priority Data
Dec. 8, 2011 (IN) 4280/CHE/2011

(51) Int. Cl. F24H 1/18; F16L 59/08

(52) U.S. Cl. CPC F24H 1/182; F16L 59/08
USPC 219/438; 220/567.3

(57) ABSTRACT

Water heaters comprising: (A) a tank, (B) a layer of insulation, e.g., polyurethane foam, and (C) a polyurethane water heater jacket wrapped about the layer of insulation, exhibit less heat loss per unit length than water heaters alike in all aspects except comprising an ABS water heater jacket. The water heater jacket can be made using RIM technology.

### BACKGROUND OF THE INVENTION

1. Field of the Invention

This invention relates to water heaters. In one aspect the invention relates to a water heater comprising a water heater jacket while in another aspect, the invention relates to a water heater jacket made by reaction injection molding (RIM).

2. Description of the Related Art

Although the size and shape of water heaters can and do vary widely, most share a common construction and mode of operation. FIG. 1 illustrates the construction of typical water heater 10. Cylindrical tank 11 is encased within insulation 12 which is encased within jacket 13. While tank 11 can comprise any of a wide variety of materials, typically tank 11 comprises relatively heavy gauge steel so as to hold the necessary pressure for its intended operation. For a typical residential application, the operating pressure is 50-100 pounds per square inch (psi), so the tank is designed and tested for a holding pressure of 300 psi using 1.5 millimeter (mm) thick steel. Since hard water at an elevated temperature is conducive to the rusting of steel, often the steel tank has a bonded glass liner (not shown).

The composition of insulation 12 can also vary widely, but typically comprises polyurethane foam. The thickness of the foam can also vary widely, and is a function, in large part, of the insulation rating desired for a particular application. For residential applications in which the tank comprises glass-lined steel and the insulation is polyurethane, an insulation layer of 35 mm thickness is typical.

The typical composition of jacket 13 is acrylonitrile butadiene styrene (ABS), polypropylene or steel (3 mm thick). The jacket provides protection for the insulation and an aesthetic appearance to the water heater in general. For a jacket of ABS or polypropylene or steel construction, additional qualities include a glossy surface finish, and impact and scratch resistance.

FIG. 2 is a top plan schematic of a water heater comprising a tank, foam insulation and jacket.

Other components of water heater 10 include power supply 14 by which to heat the water (here shown as an electric supply which includes anode rod 15, upper heating element 16 and lower heating element 17). In other embodiments the water in tank 11 is heated through another source of energy, e.g., natural gas, solar, etc., and would include appropriate equipment, e.g., a burner (not shown), for converting the energy into heat.

Cold water enters tank 11 through cold water supply 18 and hot water exists tank 11 through hot water outlet 19. Tank 11 is further equipped with upper and lower thermostats 20 and 21, respectively, and high temperature cutoff 22 to control the temperature of the water. Upper and lower access panels 23 and 24 protect thermostats 20 and 21, respectively, from accidental impacts and provide a general aesthetic value to the water heater. Tank 11 is also equipped with pressure relief valve 25 and drain valve 26.

Original equipment manufacturers (OEM) of water heaters have a continuing interest in improving the efficiency and look of their water heaters and, of course, lowering their manufacturing costs. One water heater component of present interest is the water heater jacket. In particular, OEMs are interested in finding a substitute for ABS, polypropylene and steel but one with a low tooling cost, low development time, good surface finish and added functional benefits, e.g., higher impact resistance and added thermal insulation.

### SUMMARY OF THE INVENTION

In one embodiment the invention is a water heater jacket comprising polyurethane. In one embodiment, the polyurethane water heater jacket is made by reaction injection molding. In one embodiment the invention is a water heater comprising: (A) a tank, (B) a layer of insulation positioned about the tank, and (C) a polyurethane water heater jacket wrapped about at least a part of the layer of insulation. In one embodiment, the layer of insulation is PU foam in contact with both the tank and jacket. In one embodiment the foam insulation is injected between the tank and insulation.

### BRIEF DESCRIPTION OF THE DRAWINGS

FIG. 1 is a cut-away view of an electric water heater.

FIG. 2 is a top plan view of a schematic of a water heater comprising a tank, insulation wrap and an outer jacket.

FIG. 3A is a schematic of an embodiment of one half of a water heater jacket made by RIM technology.

FIG. 3B is a schematic of an embodiment of a water heater comprising two halves of a water heater jacket joined together to encase a water heater tank and insulation.

FIG. 4 is a schematic of the water heater dimensions used in the calculation of the exemplary baseline and inventive models heat loss per unit length.

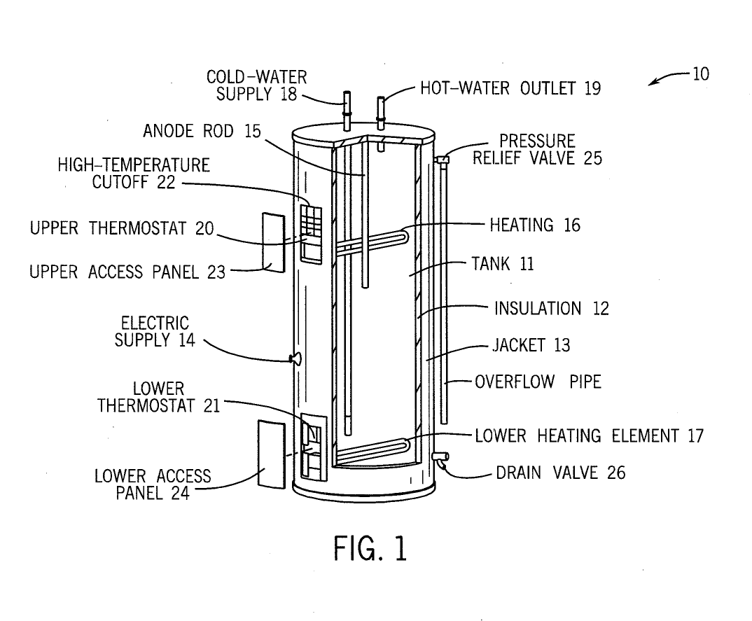

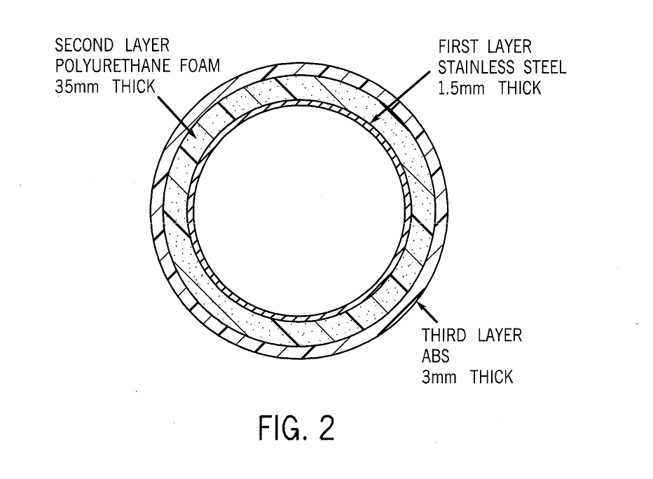

### DETAILED DESCRIPTION OF THE PREFERRED EMBODIMENT

### Definitions

The numerical ranges in this disclosure are approximate, and thus may include values outside of the range unless otherwise indicated. Numerical ranges include all values from and including the lower and the upper values, in increments of one unit, provided that there is a separation of at least two units between any lower value and any higher value. As an example, if a compositional, physical or other property, such as, for example, thickness, etc., is from 100 to 1,000, then all individual values, such as 100, 101, 102, etc., and sub ranges, such as 100 to 144, 155 to 170, 197 to 200, etc., are expressly enumerated. For ranges containing values which are less than one or containing fractional numbers greater than one (e.g., 1.1, 1.5, etc.), one unit is considered to be 0.0001, 0.001, 0.01 or 0.1, as appropriate. For ranges containing single digit numbers less than ten (e.g., 1 to 5), one unit is typically considered to be 0.1. These are only examples of what is specifically intended, and all possible combinations of numerical values between the lowest value and the highest value enumerated, are to be considered to be expressly stated in this disclosure. Numerical ranges are provided within this disclosure for, among other things, the wall thickness of various water heater component parts.

“Water heater” and like terms means equipment designed to hold and heat water or other liquid and comprising a tank, a layer of insulation, and a protective jacket.

“Tank” and like terms means the container in which the water or other liquid is held. The size in terms of volume can vary widely and to convenience with representative sizes including 10-60 gallons, or 15-20 gallons.

“Layer of insulation” and like terms means the space between the outer surface of the tank and the inner surface of the jacket. This space can be filled with any material (solid, liquid or gas) that provides protection against heat loss from the tank to the environment. In one embodiment, the space is a vacuum, partial or full. In one embodiment, the space is filled with an inert material, e.g., sand. In one preferred embodiment, the space is filled with PU insulation which can vary in thickness but is typically at least 15 mm or more in thickness, more preferably at least 30 or 35 mm in thickness.

“Jacket” and like terms means the outer shell of the water heater that, together with the wall of the tank, creates the space for the layer of insulation.

### Reaction Injection Molding (RIM)

RIM and its kindred processes, RRIM (reinforced reaction injection molding) and SRIM (structural reaction injection molding) are well known in the art. In these processes, an isocyanate composition is referred to as the “A” Component, and the “B” Component refers to the composition comprising a polymeric diol which component may optionally include other isocyanate-reactive material, e.g., a difunctional chain extender. The reagents may be blended in a suitable container and agitated at a temperature from 20° C. to 100° C. for a time between five and sixty minutes using a high sheer blade such as a Cowles blade, at a rotational speed of 50 to 2500 revolutions per minute (rpm). Preferably Component B is mixed and processed at or near ambient (20° C.) temperature.

The “A” and “B” Components are placed in separate containers, which are generally equipped with agitators, of a RIM machine in which the temperature of the “A” Component is 20° C. to 125° C. Preferably the temperature for processing and mixing the isocyanate is below 50° C., particularly if the isocyanate contains a catalyst or latent catalyst for the diol-isocyanate reaction. The temperature of the “B” Component can be between 20° C. to 80° C., but is preferably 20° C.

The “A” Component and “B” Component are impingement mixed in a forced mix head such as, for example, a Krauss-Maffei mix head. The “A” and “B” Components are pumped to the mix head by a metering pump, for example, a Viking Mark 21A, at a discharge pressure from 700 to 5000 psi. It is sometimes necessary to maintain the component streams (A and B) within the pistons (or pumps), mix head, and all conduits connecting these components, at temperatures comparable to those which prevail within the storage tanks. This is often done by heat-tracing and/or by independent recirculation of the components.

The amounts of the “A” and the “B” Components pumped to the mix head is measured as the ratio by weight of the “A” Component to the “B” Component in which the ratio is from 9:1 to 1:9, preferably from 3:1 to 1:3, depending upon the reactants used and the isocyanate index desired. Preferably a weight ratio is employed which yields a ratio of isocyanate equivalents in stream (A) to isocyanate-reactive functional groups in stream (B) between 0.70 and 1.90, preferably 0.90 to 1.30, more preferably 0.95 to 1.10. This ratio of equivalents is percentage. The expression “isocyanate-reactive-functional-groups” are defined as the index and is often expressed as to include, but not limited to, hydroxyl groups, imine groups, primary and/or secondary amine groups, mercapto(—SH) groups and carboxylic acids, the groups being organically bound.

The “A” stream may contain up to 40% of its weight in solid fillers or reinforcements. In a preferred embodiment, the A stream contains at least 70% by weight of aromatic isocyanate species, not more than 30% by weight of fillers and/or reinforcements, and not more than 10% of other optional additives.

The impingement mixed blend of “A”/“B” streams is injected into a mold at a velocity from 0.3 pounds per second (lb/sec) to 70 lb/sec, preferably 5 to 20 lb/sec. The mold is heated to a temperature from about 20° C. to 250° C. Suitable molds are made of metal such as aluminum or steel, although other materials can be used if they can withstand the processing conditions and wear. Usually an external mold release agent is applied before the first molding. These are usually soaps or waxes which are solid at the mold temperature employed.

A molded polymer article is formed after the impingement mixture is in the mold from 1 second to 30 seconds, preferably 5 to 20 seconds. The mold is then opened and the molded product is removed from the mold. The molded product may be post cured by placing the product in an oven having a temperature between 50° C. and 250° C. for a time from one-half hour to 3 hours.

### Polyurethanes

The polyurethane (PU) used in the practice of this invention is the reaction product of a di-isocyanate, one or more polymeric diol(s), and optionally one or more difunctional chain extender(s). The PU may be prepared by the prepolymer, quasi-prepolymer, or one-shot method. The di-isocyanate forms a hard segment in the PU and may be an aromatic, an aliphatic, or a cyclo-aliphatic di-isocyanate or a combination of two or more of these compounds. One nonlimiting example of a structural unit derived from di-isocyanate (OCN—R—NCO) is represented by formula (I):

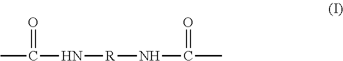

in which R is an alkylene, cyclo-alkylene, or arylene group. Representative examples of these di-isocyanates can be found in U.S. Pat. Nos. 4,385,133, 4,522,975 and 5,167,899. Nonlimiting examples of suitable di-isocyanates include 4,4′-di-isocyanatodiphenyl-methane, p-phenylene di-isocyanate, 1,3-bis(isocyanatomethyl)-cyclohexane, 1,4-di-isocyanato-cyclohexane, hexamethylene di-isocyanate, 1,5-naphthalene di-isocyanate, 3,3′-dimethyl-4,4′-biphenyl di-isocyanate, 4,4′-di-isocyanato-dicyclohexylmethane, 2,4-toluene di-isocyanate, and 4,4′-di-isocyanato-diphenylmethane.

The polymeric diol forms soft segments in the resulting PU. The polymeric diol can have a molecular weight (number average) in the range, for example, from 200 to 10,000 g/mole. More than one polymeric diol can be employed. Nonlimiting examples of suitable polymeric diols include polyether diols (yielding a “polyether PU”); polyester diols (yielding a “polyester PU”); hydroxy-terminated polycarbonates (yielding a “polycarbonate PU”); hydroxy-terminated polybutadienes; hydroxy-terminated polybutadiene-acrylonitrile copolymers; hydroxy-terminated copolymers of dialkyl siloxane and alkylene oxides, such as ethylene oxide, propylene oxide; natural oil diols, and any combination thereof. One or more of the foregoing polymeric diols may be mixed with an amine-terminated polyether and/or an amino-terminated polybutadiene-acrylonitrile copolymer.

The difunctional chain extenders can be aliphatic straight or branched chain diols having from 2 to 10 carbon atoms, inclusive, in the chain. Illustrative of such diols are ethylene glycol, 1,3-propanediol, 1,4-butanediol, 1,5-pentanediol, 1,6-hexanediol, neopentyl glycol, and the like; 1,4-cyclohexanedimethanol; hydroquinonebis-(hydroxyethyl)ether; cyclohexylenediols (1,4-, 1,3-, and 1,2-isomers), isopropylidenebis(cyclohexanols); diethylene glycol, dipropylene glycol, ethanolamine, N-methyl-diethanolamine, and the like; and mixtures of any of the above. As noted previously, in some cases, minor proportions (less than about 20 equivalent percent) of the difunctional extender may be replaced by trifunctional extenders, without detracting from the thermoplasticity of the resulting PU; illustrative of such extenders are glycerol, trimethylolpropane, and the like.

The chain extender is incorporated into the polyurethane in amounts determined by the selection of the specific reactant components, the desired amounts of the hard and soft segments, and the index sufficient to provide good mechanical properties, such as modulus and tear strength. The polyurethane compositions can contain, for example, from 2 to 25, preferably from 3 to 20 and more preferably from 4 to 18, wt % of the chain extender component.

Optionally, small amounts of monohydroxyl functional or monoamino functional compounds, often termed “chain stoppers,” may be used to control molecular weight. Illustrative of such chain stoppers are the propanols, butanols, pentanols, and hexanols. When used, chain stoppers are typically present in minor amounts from 0.1 to 2 weight percent of the entire reaction mixture leading to the polyurethane composition.

The equivalent proportions of polymeric diol to the extender can vary considerably depending on the desired hardness for the PU product. Generally speaking, the equivalent proportions fall within the respective range of from about 1:1 to about 1:20, preferably from about 1:2 to about 1:10. At the same time the overall ratio of isocyanate equivalents to equivalents of active hydrogen containing materials is within the range of 0.90:1 to 1.10:1, and preferably, 0.95:1 to 1.05:1.

### Water Heater Jacket

The water heater jacket of this invention is made using conventional RIM, RRIM or SRIM technology and the isocyanates, diols and extenders described above. The jacket can be of any design, but typically is designed and sized to encase or encapsulate the tank and insulation layers with appropriate openings for piping and instrumentation, e.g., thermostats. The thickness of the jacket can also vary widely, but is typically at least 1 mm, more preferably at least 2 mm, and even more preferably at least 3 mm. The maximum thickness of the jacket typically does not exceed 10 mm, more typically does not exceed 7 mm and even more typically does not exceed 5 mm.

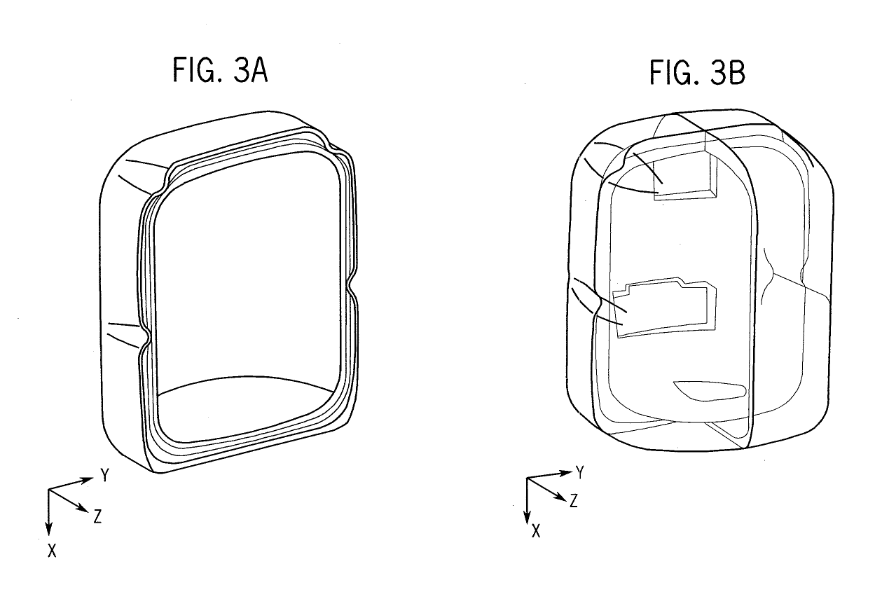

In one embodiment, as shown in FIGS. 3A and 3B, the jacket comprises two halves that when fitted about the tank and insulation fully or nearly fully encapsulates the tank and insulation. FIG. 3A shows one half of the jacket, and FIG. 3B shows the two halves joined together to encase a water heater tank and the insulation about the tank. The two halves can be joined by any means including, but not limited to, mechanical fasteners (e.g., one or more metal or elastic bands), adhesive, compression or snap fit (e.g., mated coupling edges of the two halves), and the like. Whatever the joining means, preferably the jacket can be easily dissembled to provide ready access to the insulation and tank for maintenance and repair.

In one embodiment the jacket is formed by RIM, RRIM or SRIM technology directly over the insulation layer of the water heater during the manufacture of the water heater. In this embodiment the jacket is essentially a one piece covering with appropriate openings for piping and instrumentation for the tank and insulation layer. This embodiment is more adapted to the manufacture of small (e.g., 15 to 20 gallons), electric water heaters.

As compared to a water jacket alike in all aspects except comprising ABS, a RIM-produced jacket exhibits (i) better mechanical and thermal properties, (ii) lower heat loss per hour and achieves a better energy star rating (a rating provided by a governmental certifying body that measures the energy efficiency of a system/equipment), (iii) better impact properties (important for appliance drop test, e.g., after manufacture, the water heater is subjected to impacts incidental to transport), (iv) better gloss and surface finish, (v) cost savings in tooling, (vi) a shorter product development cycle (typically 2-3 months), (vii) shorter product life cycle because of low tooling cost, (viii) low manufacturing energy requirements, and (ix) same cycle time.

The water heater of this invention comprises (A) a tank or inner cylinder, typically comprising a heavy gauge steel, e.g., 5 mm or more in thickness, (B) a layer of insulation, typically a foam insulation wrapped about and in contact with the tank, typically comprising PU foam of 35 or more millimeters in thickness, and (C) a RIM, RRIM or SRIM PU jacket of 1-5 mm in thickness. The insulation layer can completely cover the tank (with appropriate openings for piping and instrumentation), or it can cover less than the complete surface area of the tank such that when encased in the jacket, one or more air spaces exist between the tank and the jacket. Other insulation foams include, but are not limited to, polystyrene and polyolefin.

The thickness of the jacket is a function of, among other things, the desired mass and thermal insulation efficiency of the water heater, and the cost of its manufacture. The jacket can also vary widely in (i) length, e.g., 200 mm to 1,000 or more millimeters, (ii) density, e.g., 500 to 1,200 kilograms per cubic meter (Kg/m³), and (iii) thermal conductivity, e.g., 0.025 to 0.09 Watts per meter degrees Kelvin (W/m° K). The jacket can comprise any one of a number of different designs with a preference for two halves that, when joined, encase the tank and insulation layer with appropriate openings for piping and instrumentation. If the halves are joined by an adhesive, appropriate adhesives include, but are not limited to, acrylics, acrylic/epoxies and expandable epoxies.

### SPECIFIC EMBODIMENTS

### Heat Loss Calculations Using Classical Closed Form Solution

### Two-Dimensional Thermal Calculations for Heat Loss

Baseline Model

The baseline model comprises a steel tank of 1.5 mm in thickness and 303 mm in diameter covered with 35 mm of PU foam which, in turn, is covered with a jacket of 3 mm ABS. The temperature at the inner wall of the steel tank is 71° C. and 23° C. at the outer wall of the ABS jacket. Table 1 reports the material properties and thickness details of each layer of the baseline model. Table 2 reports the thermal conductivity of each material of the baseline model.

TABLE 1
Material and Thickness of the Baseline Model

| Component | | |
|---|---|---|
| Name | Material | Thickness |
| Inner Tank | Stainless Steel | 1.5 mm |
| Insulation | Polyurethane Foam | 35 mm |
| Outer Body | Acrylonitrile Butadiene Styrene (ABS) | 3 mm |

TABLE 2
Thermal Properties of the Materials of the Baseline Model

| | Thermal |
|---|---|
| Material | Conductivity |
| Stainless Steel | 43 W/m ° K |
| Polyurethane Foam | 0.02 W/m ° K |
| Acrylonitrile Butadiene Styrene | 0.33 W/m ° K |
| (ABS) | |

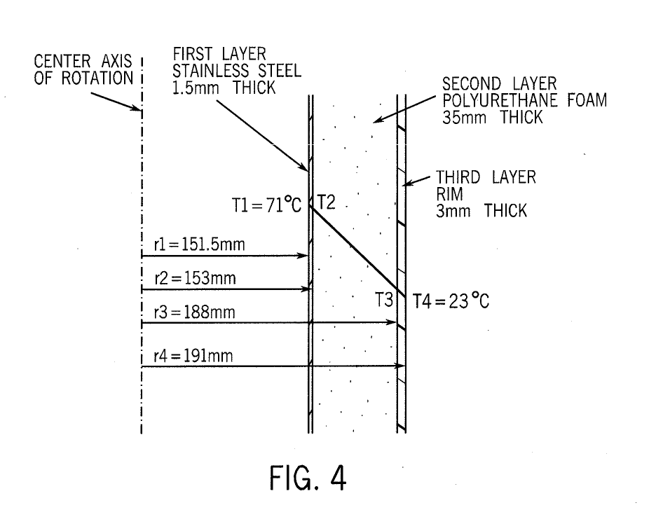

FIG. 4 shows the critical dimension of each layer and input temperature conditions for the baseline model. Heat loss calculations are done using classical closed form solution for conduction mode heat transfer. The temperature inputs for the calculations are the inner steel surface temperature 71° C. and outer ambient temperature 23° C. Formula I below is the classical closed form solution for heat transfer through composite cylinders by conduction mode of heat transfer.

$$\frac{Q}{L} = \frac{2 π ( {T}_{1} - {T}_{4} )}{\frac{ln ( {r}_{2} / {r}_{1} )}{{k}_{1}} + \frac{ln ( {r}_{3} / {r}_{2} )}{{k}_{2}} + \frac{ln ( {r}_{4} / {r}_{3} )}{{k}_{3}}} \qquad Formula I$$

### Where:

Q is heat transfer through the composite cylinder;
L is length of the composite cylinder;
r₁ is inner radius of stainless steel cylinder=151.5 mm;
r₂ is outer radius of stainless steel cylinder=153 mm;
r₃ is outer radius of polyurethane foam cylinder=188 mm;
r₄ is outer radius of ABS cylinder=191 mm;
T₁ is temperature at inner wall of stainless steel=71° C.
T₄ is ambient temperature at outer wall of ABS=23° C.;
k₁ is thermal conductivity of steel=43 W/m° K;
k₂ is thermal conductivity of polyurethane=0.02 W/m° K; and
k₃ is thermal conductivity of ABS=0.33 W/m° K.
Units used for calculation: W=Watt, m=meter, and ° K=degrees Kelvin
Q/L (Heat transfer per unit length)=29.13 W/m

The heat loss per unit length for baseline system is 29.13 W/m.

Inventive Model

The inventive design is same as the baseline design except that the ABS water heater jacket material is replaced with a PU RIM material. The critical dimension of each layer and input temperature conditions for the inventive design are the same as those shown in FIG. 4. The material properties and thickness details of each layer of the inventive model are reported in Table 3, and the thermal conductivity of each material of the inventive model are reported in Table 4.

TABLE 3
Material and Thickness of the Inventive Model

| Component Name | Material | Thickness |
|---|---|---|
| Inner Tank | Stainless Steel | 1.5 mm |
| Insulation | Polyurethane Foam | 35 mm |
| Outer Body | Reaction Injection Molding (RIM) | 3 mm |

TABLE 4
Thermal Properties of the Materials of the Inventive Model

| | Thermal |
|---|---|
| Material | Conductivity |
| Stainless Steel | 43 W/m ° K |
| Polyurethane Foam | 0.02 W/m ° K |
| Reaction Injection Molding (RIM) | 0.07 W/m ° K |

Using Formula I above and the same values for the variables as used for the calculation of the baseline model, except replacing the k₃ thermal conductivity of ABS (0.33 W/m° K) with the K3 thermal conductivity of PU-RIM (0.07 W/m° K), the heat loss per unit length for the inventive model is 28.64 W/m. The inventive model thus shows a 0.49 W/m reduction in heat loss as compared to the baseline model.

1. A water heater (10) comprising (i) a tank, (ii) a layer of insulation (12) about the tank, and (iii) a polyurethane (PU) water heater jacket about the layer of insulation.

2. The water heater (10) of claim 1 in which the tank (11) comprises heavy gauge steel.

3. The water heater (10) of claim 2 in which the steel is 5 mm or more in thickness, and the layer of insulation (12) is PU foam insulation wrapped about and in contact with the tank (11).

4. The water heater (10) of claim 3 with a tank capacity of 10-60 gallons (38-227 liters), the thickness of the PU foam (12) is at least 15 mm, and the thickness of the jacket is 1-5 mm.

5. The water heater (10) of claim 4 equipped with an electric heating system (17).

6. The water heater (10) of claim 1 in which the jacket comprises two halves that are joined with one another such that the tank (11) and layer of insulation (12) are encased except for appropriate openings for piping and instrumentation.

7. The water heater (10) of claim 6 in which the two halves of the jacket are joined by elastic or metallic bands.
